(19) United States
(12) Patent Application Publication
(10) Pub. No.: US 2009/0172350 A1
(43) Pub. Date: Jul. 2, 2009

(54) Non-volatile processor register

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, SUNNYVALE, CA (US)

(21) Appl. No.: 12/005,685

(22) Filed: Dec. 28, 2007

(51) Int. Cl. G06F 9/00

(52) U.S. Cl. 712/4; 712/E09.001

(57) ABSTRACT

A processor using a vertically configured non-volatile memory array that can retain values through a power failure is disclosed. The processor may include a register block configured to store and retrieve one or more values, the register block being a vertically configured non-volatile memory array, an arithmetic block configured to perform an arithmetic operation on the one or more values, and a control block configured to control the register block, the arithmetic block, and a memory block. The vertically configured non-volatile memory array may include a plurality of two-terminal memory elements. The two-terminal memory elements may be resistivity-sensitive and store data in the absence of power. The two-terminal memory elements store data as plurality of conductivity profiles that can be non-destructively read by applying a read voltage across the terminals of the memory element and data can be written by applying a write voltage across the terminals.

### CROSS-REFERENCES TO RELATED APPLICATIONS

This application is related to U.S. patent application Ser. No. 11/095,026, filed Mar. 30, 2005, and titled “Memory Using Mixed Valence Conductive Oxides.”

### FIELD OF THE INVENTION

The present invention relates to semiconductors. More specifically, non-volatile memory in processor registers is discussed.

### BACKGROUND

Processor functionality utilizes registers and stack locations to hold values used in the operations of the processor. The values can be pointers or addresses to memory locations, control data, or data values. The registers are commonly made up of random access memory (RAM). Dynamic random access memory (DRAM) is inexpensive but requires a refresh operation to maintain its values. Static random access memory is expensive and takes up a great deal of space. Flash RAM requires an erase operation before registers can be rewritten. In addition, DRAM, SRAM and Flash RAM all lose their values upon a power loss. Because the last state of the processor is lost, the processor has to start over as if it had never been running. That is, the processor requires an initialization or boot up routine prior to operating the processor. This is time consuming and inefficient.

A processor may also have a read only memory (ROM) to store assembly instructions, and a basic input and output system (BIOS). However, these programs are frequently read and loaded into RAM to be executed to achieve optimum speed and to store variables within the code. In addition, if there are changes to the assembly instructions or BIOS, the ROM must be replaced. These limitations take time and are inefficient.

Context switching is the process of sharing execution time between 2 or more programs. That is the processor is shared between 2 or more programs that become active and inactive depending on the context switch. Context switching may be used in multiplexing systems. In some cases, each program is allotted a certain time slice of the processor. Each program can utilize their time slice to execute as much as can be accomplished, then the processor is switched to a different program for it's time slice. In other cases, each program has an interrupt that is used to interrupt the current processor function to run the new program. Here one program may be executed until an interrupt is received to switch the processor. However, to implement the context switching the processor register values are moved out of the registers and loaded in memory when a program has finished executing. Then upon that program being executed again, the register values are retrieved from memory and loaded into the registers. This moving of register values is time consuming and inefficient. Further, the register values are at risk of being lost as the memory is usually RAM which cannot hold values through a power loss.

There are continuing efforts to improve memory for use in processors.

### BRIEF DESCRIPTION OF THE DRAWINGS

The present invention will be readily understood by the following detailed description in conjunction with the accompanying drawings, and like reference numerals designate like structural elements. Although the Drawings depict various examples of the invention, the invention is not limited by the depicted examples. Furthermore, the depictions are not necessarily to scale.

FIG. 1 illustrates an exemplary processor utilizing vertically configured non-volatile memory arrays for the registers;

FIG. 2A illustrates an exemplary physical layout of a processor utilizing stackable non-volatile registers in the memory layer;

FIG. 2B illustrates an exemplary physical layout of a processor utilizing stackable non-volatile memory in the memory layer;

FIG. 3A illustrates an exemplary process for resuming operations after a power loss;

FIG. 3B illustrates an exemplary process for resuming operations after a power loss utilizing a initialization routine;

FIG. 4A illustrates an exemplary program counter switch;

FIG. 4B illustrates an exemplary context block switch;

FIG. 5 illustrates an exemplary processor utilizing a vertically configured non-volatile memory array for both the register block and the memory block;

FIG. 6 illustrates an exemplary physical layout of a processor including processor logic, registers, and memory configured in a vertically configured non-volatile memory array; and

FIG. 7 illustrates an exemplary process for a cold start.

### DETAILED DESCRIPTION

The invention may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

In general this disclosure details methodologies to employ the vertically configured non-volatile memory array in a processor. Some embodiments include using the vertically configured non-volatile memory array for the processor registers. Some embodiments include using vertically configured non-volatile memory array for both the registers and the memory of a processor. These embodiments and their variations are detailed below.

The vertically configured non-volatile memory technology is described U.S. patent application Ser. No. 11/095,026, filed Mar. 30, 2005, and titled “Memory Using Mixed Valence Conductive Oxides,” hereby incorporated by reference in its entirety and for all purposes, describes two terminal memory cells that can be arranged in a cross point array. The application describes a two-terminal memory element that changes conductivity when exposed to an appropriate voltage drop across the two terminals. A plurality of the two-terminal memory elements can be arranged in a cross-point array configuration. Multiple layers of the cross-point arrays may be vertically stacked upon one another to form the aforementioned vertically stacked array configuration. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (e.g., such as selection circuitry). The circuitry can be in a logic plane fabricated on a substrate (e.g., a silicon Si wafer) and the memory array can be positioned on top of the substrate. The memory element stores data as a plurality of conductivity profiles that can be non-destructively determined by applying a read voltage across the terminals of the memory element. The memory element retains stored data in the absence of power. The two-terminal memory elements can be arranged in a cross point array such that one terminal is electrically coupled with an x-direction line and the other terminal is electrically coupled with a y-direction line.

Both the electrolytic tunnel barrier and the mixed valence conductive oxide do not need to operate in a silicon substrate and, therefore, can be fabricated above circuitry being used for other purposes. The two-terminal memory elements can be arranged in a cross point array such that one terminal is electrically coupled with an x-direction line and the other terminal is electrically coupled with a y-direction line. A stacked cross point array consists of multiple cross point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½-V_{W1} to the y-direction line) it switches to a low resistive state. When a second write voltage V_{W2} is applied across the memory element, (typically by applying ½ V_{W2} to the x-direction line and ½-V_{W2} to the y-direction line) it switches to a high resistive state. Typically, memory elements using electrolytic tunnel barriers and mixed valence conductive oxides require V_{W1} to be opposite in polarity from V_{W2}.

### Vertically Configured Non-Volatile Memory Arrays for Registers

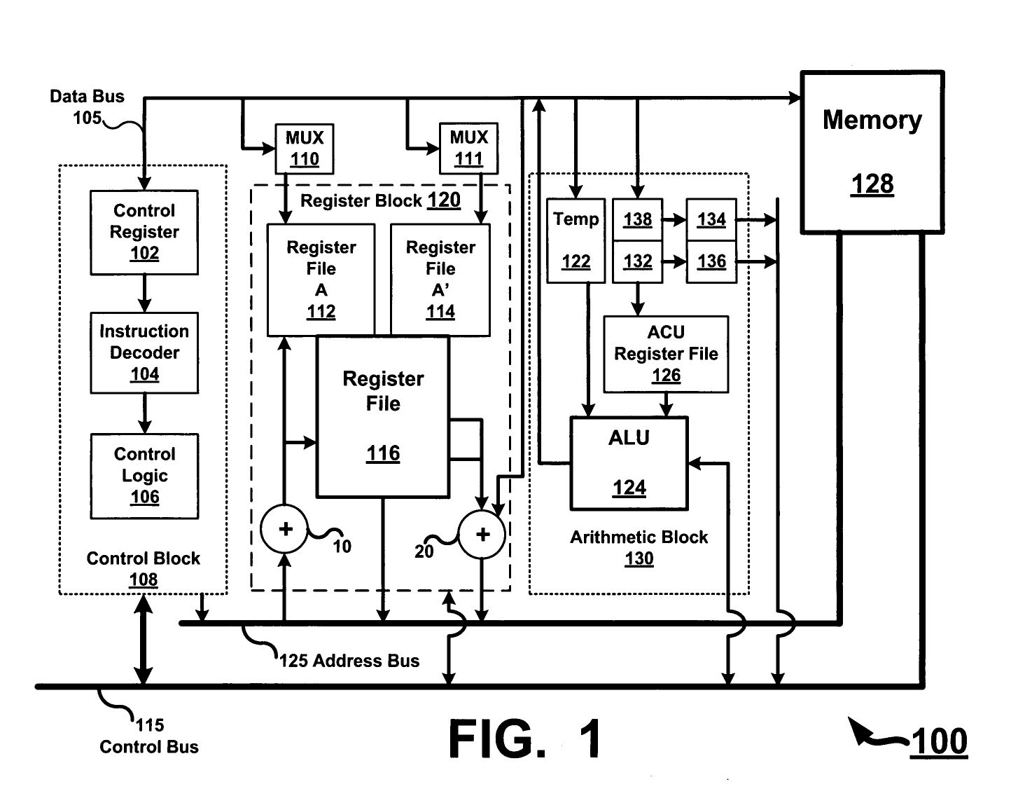

FIG. 1 illustrates an exemplary processor 100 utilizing vertically configured non-volatile memory arrays for the registers. Using vertically configured non-volatile memory arrays for the registers may allow consecutive writes to the registers and recovery without executing a boot up routine. In some embodiments, processor 100 may include control block 108, register block 120, arithmetic block 130, and memory 128. The limited functions of processor 100 were simplified to help clarify the discussion. Different and more complex processor architectures may be used as well.

Memory block 128 may be configured in SRAM, DRAM, ROM, electronically erasable programmable read only memory (EEPROM) or Flash memory. Memory block 128 may include memory locations identifiable by addresses. These memory locations may be used to store data values, address, constants, instruction codes, or other data. Memory block 128 may also be constructed of vertically configured non-volatile memory array as further discussed below in reference to FIG. 5.

Further, processor 100 may include data bus 105, control bus 115, and address bus 125. Data bus 105 handles data value traffic from one block to another. Data values may include any instructions or commands and data values. For example, memory block 128 may include data values and instructions. Data bus 105 may carry those instructions and data values from memory block 128 to control block 108. Address bus 125 may transfer addresses or address data from one block to another in the processor. Addresses or address data may refer to memory locations in memory block 128. For example, an instruction may detail that memory location or address A is to be read from memory block 128. Address A may be sent to memory block 128 via address bus 125. Control bus 115 may transfer control signals from one block to another. Control signals may include setting or resetting a bit in a certain register or memory location. For example, control block 108 may send control data to the read line of memory block 128 to indicate a read instruction. That is, memory block 128 may receive address A on address bus 125 and a control signal on control bus 115 to tell the memory block 128 to retrieve the contents of address A from memory block 128. In another example, memory block 128 may receive address B on address bus 125, a data value D on data bus 105, and a control signal C on control bus 115 to tell the memory block 128 to write value D into address B in memory block 128.

Control block 108 may be configured to manage or control the other blocks. That is, control block 108 may send a control signal instructing memory block 128 to retrieve the data value in an address location. A control signal may include a certain bit pattern being written to a particular address, a high signal written to a particular bit, or the like. The “0” or “1” value in a particular bit location may be configured to cause an action to occur. For example, a bit may cause a multiplexer to select a particular output, or set arithmetic logic unit (ALU) 124 to a particular operation, or cause a value on data bus 105 to be stored in a particular register, or cause a value to be stored in or read from memory block 128, or similar processor operations. Control block 108 may include control register 102, instruction decoder 104 and control logic 106. Control register 102 may hold an instruction value. The instruction value may be loaded from memory block 128. Control block 108 may receive instructions and data values via data bus 105.

A processor, such as processor 100, may have a set of instructions that it can perform. The collection of instructions may be implemented as bit patterns. That is, each instruction may have a bit pattern. The bit patterns also may be associated with short words, the words being assembly language. The list of instructions for processor 100 may be stored in ROM. TABLE 1 lists an example set of assembly language instructions, the example associated bit patterns, and the example short words that may be used in processor 100.

TABLE 1

| | | Bit |
|---|---|---|
| Short Words | Instruction | Pattern |
| LOADA mem | Load register A from memory address mem | 0x01 |
| LOADTEMP | Load register Temp from memory address | 0x02 |
| mem | mem | |
| CONTEMP | Load a constant value into register Temp | 0x03 |
| con | | |
| SAVETemp | Save register Temp to memory address mem | 0x04 |
| mem | | |
| SAVEOutput | Save output of ALU to memory address mem | 0x05 |
| mem | | |
| ADD mem | Add A and Temp and store result in mem | 0x06 |
| SUB mem | Subtract A and Temp and store result in | 0x07 |
| | mem | |
| MUL mem | Multiply A and Temp and store result in mem | 0x08 |
| DIV mem | Divide A and Temp and store result in mem | 0x09 |
| COM | Compare A and Temp and store result in F | 0x0A |
| JUMP addr | Jump to an address | 0x0B |
| JEQ addr | Jump, if equal to address addr | 0x0C |
| JNEQ addr | Jump, if not equal, to address addr | 0x0D |
| JG addr | Jump, if greater than, to address addr | 0x0E |
| JGE addr | Jump, if greater than or equal, to address | 0x0F |
| | addr | |
| JL addr | Jump, if less than, to address addr | 0x10 |
| JLE addr | Jump, if less than or equal, to address addr | 0x11 |
| STOP | Stop execution | 0x12 |

Control register 102 may pass the instruction to instruction decoder 104. Instruction decoder 104 may decode the instruction value into the signals that coordinate the other blocks in the processor to execute the desired function. The function may include a set of signals delivered over several clock cycles. The functions may be executed via control signals to register block 120 and arithmetic block 130. For example, an instruction may be loaded into control register 102 from memory block 128. The instruction may be passed to instruction decoder 104. Instruction decoder 104 may determine that the instruction is an ADD <mem> instruction. Control logic 106 may set the operation of ALU 124 to addition, and then may store the result into address <mem>in memory block 128. In some embodiments, an additional register may be located at the output of ALU 124 to latch results prior to their ultimate destination which may include memory block 128 or register block 120. Each instruction may be decoded, broken down, or parsed into a set of sequential operations that manipulate other components in the processor. Some instructions may consume 2-3 clock cycles, other instructions consume more clock cycles. Clock cycles may be used to trigger operations. For example, some operations may be triggered at the rise of a clock cycle, others at the drop of the clock cycle. Depending on the type of trigger and the number of operations in an instruction, the operation may consume several iterations of rising and falling clock cycles to execute the function. Other instruction sets and processing operations may be used as well. For example, reduced instruction set computers (RISC) may execute instructions within one clock cycle. Whereas a complex instruction set computer (CISC) may use multiple clock cycles to execute an operation, however, the operations may include more functionality.

Arithmetic block 130 may include Arithmetic logic unit (ALU) 124, accumulator register (ACU) 126, Temp register 122, and registers 132, 134, 136, 138. ALU 124 may perform the mathematical operations specified by control block 108. The mathematical operations may be performed on the values loaded into registers 138,132, and Temp 122. Registers 134,136 may be used as flags to indicate certain results of the mathematical operations. The flag values may indicate zero, overflow, or bit test results. These flags may be fed back into control block 108 for decision making purposes. ACU 126 may store the content of an arithmetic instruction. In some embodiments, the output of ALU 124 may be stored in registers 132 and 138, and then may be stored in ACU 126. In some embodiments, the output of ALU 124 may be stored directly in ACU 126.

Register block 120 may include the working registers which may be used by control block 108 and arithmetic block 130. Register block 120 may include Register file A 112, register file A′ 114, register file 116, adder 10, and adder 20. In some embodiments register file 116 may include index registers, stack pointer registers, and program counter registers. In some embodiments, index registers may be used to index operations. For example, an address of where to read or write a value may be stored in index registers such that sequential reads or writes are possible. In some embodiments, the output of an index register may be combined with a value on the data bus in adder 20 with the data bus value acting as an offset. That is, the data value coming from the data bus is added to an address stored in an index register to create another address that is then placed on address bus 125.

In some embodiments, a stack pointer in register file 116 may be used to hold the address of the next memory location in memory block 128 to return to upon a return instruction. For example, an operation may use a subroutine. Having the address of the memory location to return to allows the processor to execute the subroutine and get back to the proper location in the main program.

In some embodiments, a program counter register in register file 116 may hold the memory location address for the next value to be fetched. Here, fetching may refer to retrieving, getting, reading, or extracting a data value from a memory location. The output of the program counter register may be coupled to address bus 125 to indicate where a data value is to be fetched from. In some embodiments, the output of program counter register is fed into adder 10 which may increment the value by 1. The incremented value may be loaded back into program counter register to be ready to read the next value.

In some embodiments, registers file A 112 and register file A′ 114 may be used for address management or data storage. For example, data values may be retrieved from memory and stored in these registers. Storing may be referred to a latching, writing, saving, holding, or the like. The data values may be moved from register file A 112, register file A′ 114, or register file 116 into the registers 132, 138, or temp 122 of arithmetic block 130 when it is time to perform computations on them. Moving data values may refer to retrieving data values from one memory location or register and storing them or loading them in another memory location or register.

In some embodiments, register block 120 and the other registers in processor 100 may be a constructed in a vertically configured non-volatile memory array. The vertically configured memory array has the capability of receiving two consecutive writes. That is, a register of register block 120 may be written to in two consecutive writes without the need for an erase operation in between the write operations. For example, if an address to be used in a retrieve operation was written to register X. Then a second address may be written to register X without an erase operation separating the two write or save operations. More specifically, a program counter in register block 120 that held an address may have a second address written to it without an erase operation separating the two write operations. The second address may be an address sent through adder 20 to be incremented by 1 and rewritten to the program counter. Another example may include control register 102. Control register 102 may hold an instruction retrieved from memory block 128. This register, being configured in vertically configured non-volatile memory array, may receive a second instruction without an erase operation to clear the register. That is, control register 102 may sequentially store or write instructions without an erase operation in between the write operations.

The vertically configured non-volatile memory array used to configure the registers in processor 100 may store values through a power loss. That is, the working data values, and register values such as stack pointers, index values, program counters and other working data do not lose their values upon power loss. The values may be retained in the registers and available after the power is restored. For example, register block 120 may hold many of the working registers in processor 100. With these values being retained through a power loss, the last state of the processor may be retained. For example, control register 102 may hold an instruction retrieved from memory block 128. This register, being configured in vertically configured non-volatile memory array, may hold its value through a power loss. That is, the instruction that was being executed when the power loss occurred would be available after power is restored. As the configured non-volatile memory array may not lose its data when the power is lost, the values in the registers may be saved and available when power is restored. These values stored in register block 120 may include the last state of processor 100 prior to a power loss. That is, since the data values are retained upon power loss, the last state of processor 100 may be retained in the registers of processor 100.

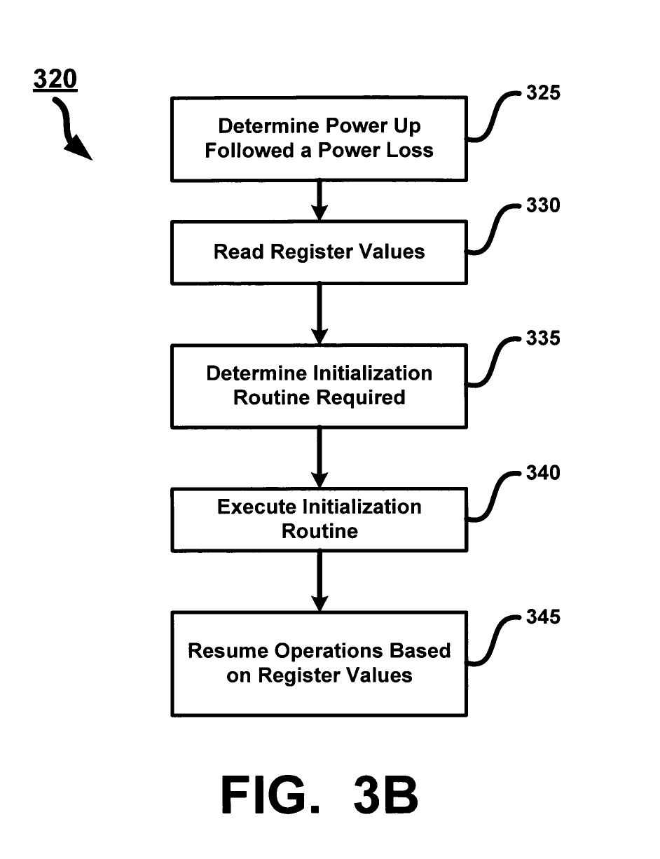

The availability of the last state of the register data, including program counter, stack pointer and arithmetic register values, after a power loss may allow processor 100 to restart directly from that retained or last state. Restarting from that last state may allow processor 100 to skip a boot up process upon power recovery. This process is further described in reference to FIG. 3A.

In some embodiments, the vertically configured non-volatile memory array can be used to replace the registers in a processor in a 1-for-1 manner. That is the vertically configured non-volatile memory array may be configured as individual cells or a small group of cells to create an individual register or small cluster of registers called a stackable non-volatile register. This 1-for-1 replacement may allow a processor the added features of consecutive writes and storage of data through a power loss without other changes to the logic or layout of the processor. In other embodiments, not only are the existing registers replaced with stackable non-volatile registers but because of their petite size, additional stackable non-volatile registers may be added to the processor. The additional registers may provide faster processing, allow for additional features or operations and may not add additional cost or consume additional die space or chip space. In some embodiments, the vertically configured non-volatile memory arrays used for the processor memory may be implemented in a block of memory. That is, instead of using one cell or a small group of cells, a larger array of cells may be implemented together as a stackable non-volatile register memory. The processor registers may be implemented using stackable non-volatile registers, as stackable non-volatile memory, or a combination of both referred to as stackable non-volatile storage.

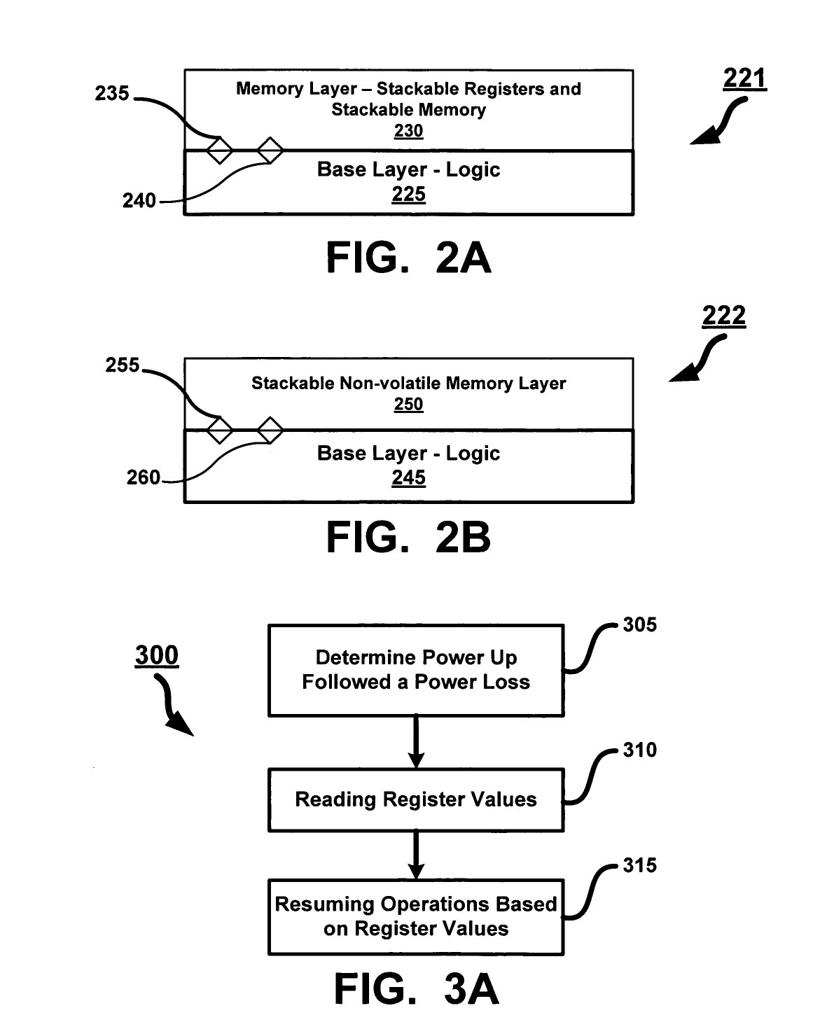

FIG. 2A illustrates an exemplary physical layout 221 of a processor utilizing stackable non-volatile registers in a memory layer. In some embodiments, the stackable non-volatile registers (or stackable stand alone cells) may be configured in memory layer 230 along with other memory elements such as stackable non-volatile memory (or an array of stackable cells). The logic layer 225 may be limited to the processor logic such as for example, the logic managing control block 108, register block 120, and arithmetic block 130. In some embodiments, logic layer 225 may include additional processor logic. A plurality of vias, such as vias 235 and 240, may be used to communicate between logic layer 225 and memory layer 230.

FIG. 2B illustrates an exemplary physical layout 222 of a processor utilizing stackable non-volatile memory in the memory layer. In some embodiments, the processor registers are implemented using stackable non-volatile memory (or an array of stackable cells). Here, the logic layer 245 may be limited to including processor logic, while memory layer 250 includes the stackable non-volatile memory. A plurality of vias, such as vias 255 and 260, may provide communication between logic layer 245 and memory layer 260.

In other embodiments, more than two layers may be used to configure the processor. Here, the logic layer may be stacked below two or more memory layers. Vias may be used to communicate between the logic layer and the memory layers.

FIG. 3A illustrates an exemplary process 300 for resuming operations after a power loss. In some embodiments, process 300 includes determining that the power up followed a power loss at a stage 305, reading the register values at a stage 310, and resuming operations based on register values at a stage 315. Power up may be referred to as start up, reboot, booting, power on, turning on, or similar terms. Determining that the power up followed a power loss at the stage 305 may include reading a certain bit location or register and comparing the value to a known value that indicates a power loss occurred. For example, upon a power loss some processors write a particular value in register X, perhaps value 0xFF. Since the processor utilizing the vertically configured non-volatile memory is able to store the values of the registers, during power up register X is read and if value 0xFF is the value stored in register X, the processor knows this power up is following a power loss. In some embodiments, register X may not be read but simply compared to a constant which if equal may indicate a power loss occurred. This indication informs the processor that the processor was executing an operation prior to being stopped, and that the stoppage in the operation may have been abrupt in that the operation may not have been completed. The processor then reads the register values at the stage 310 to determine the last values of the registers prior to losing power. In using vertically configured non-volatile memory, the values in the registers may be held through a power loss. The values in the registers may be indicative of the last state of the processor and may be referred to as a last state of the processor prior to power loss. For example, the working registers may contain the last values that had been loaded, the control register may contain the operation that was being executed, the ALU registers may contain the last computed values. The maintenance of these and other values may allow the processor to continue executing the operation after the power loss from the precise state it was left in before the power loss. The operations may be resumed based on the read register values at the stage 315.

In some embodiments, resuming operations uses a specialized driver that may be closely coupled to the operating system. For example, resuming operations skips the execution of a portion of the BIOS, and boot sector programs. One function of these programs is to load the operating system. An operating system driver or boot driver may be used to provide the connection between the operating system and the processor in some embodiments.

FIG. 3B illustrates an exemplary process 320 for resuming operations after a power loss utilizing an initialization routine. In some embodiments, it is not desired to begin executing from the last state of the processor. In these instances an initialization routine may be used to prepare the processor for resuming operations. In some embodiments, resuming operations with an initialization routine may include determining that the power up followed a power loss at a stage 325, reading the register values at a stage 330, determining an initialization routine is required at a stage 335, executing the initialization routine at a stage 340, and resuming operations based on register values at a stage 345. Determining that the power up followed a power loss at the stage 325 may include reading a certain bit location or register and comparing the value to a known value or constant that indicates a power loss occurred. For example, upon a power loss some processors write a particular value in a memory location or a particular register Y. Some processors may use memory address 0000:0472 to store a value of 0x1234 to indicate a reboot. The processor utilizing the vertically configured non-volatile memory is able to retain the values of the registers through a power loss. If value 0x1234 is stored in register Y, the processor knows this power up is following a power loss and is a reboot. In some embodiments, register Y may not be read but simply compared to a constant which, if equal, may indicate a power loss occurred. This indication may inform the processor that the processor was executing an operation prior to being stopped, and that the stoppage in the operation may have been abrupt in that the operation may not have been completed. The processor may then read the register values at the stage 330 to determine the last values of the registers prior to losing power. In using a vertically configured non-volatile memory array, the values in the registers may be held through a power loss. The values in the registers may be indicative of the last state of the processor and may be referred to as a last state of the processor prior to power loss. For example, the working registers may contain the last values that had been loaded, the control register may contain the operation that was being executed, the ALU registers may contain the last computed values. In some instances it may not be desirable to start from the last state. This determination may be based on the register values and may be completed at the stage 335. For example, IO registers that control external hardware may have been “high” or “on” at the last state of the processor. However, at the reboot point in time it may be unknown if it is safe to have the outputs “on”, or it may be undesirable to have the outputs “on”. A miniature initialization routine may be executed at the stage 340. A miniature initialization may not include a full boot up sequence. In some embodiments, instead of a full boot, the logic may store an initialization value in a register to indicate an address of where to begin execution. In other embodiments the initialization routine may include clearing values. For example, a register that drives a light emitting diode (LED) may be cleared in the initialization routine. In some embodiments, the initialization routine may depend on the values in the registers. After the initialization routine, the processor may resume operations based on the register values at the stage 345. That is, the operations that was executing may continue to execute just as if the execution had not been interrupted by the power loss.

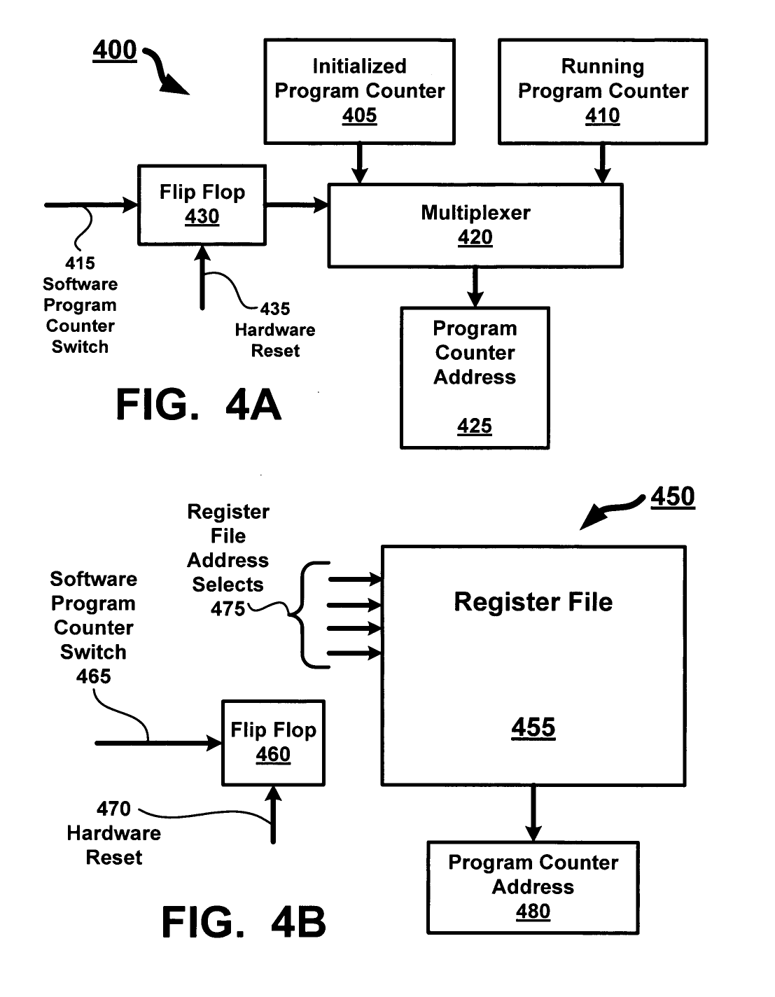

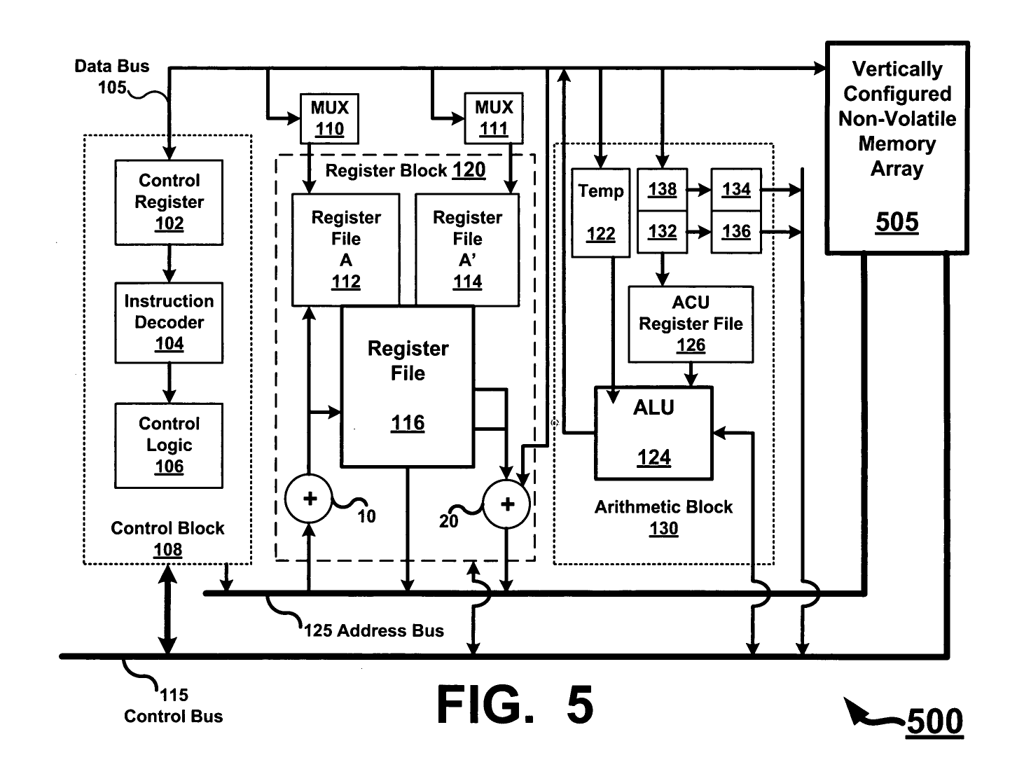

FIG. 4A illustrates an exemplary program counter switch 400. In some embodiments, executing an initialization routine may include switching program counters. That is, the processor may possess two program counters, a main or running program counter 410 and a default or initialized program counter 405. Initialized program counter 405 may be used to execute the initialization routine and running program counter 410 may hold the last value prior to power loss. That is, the main program counter or running program counter 410 may be used in normal processor operation and may store the last value of the program counter prior to power loss. Recall that a program counter may store an address location of the next memory address to be fetched or retrieved during execution. The default or initialized program counter 405 may be used when an initialization routine is used. Initialized program counter 405 may be used to hold an address of the next memory location to be fetched or retrieved in the initialization routine. Program counter address 425 may be the program counter currently in use in the processor. During normal operations, the main or running program counter 410 may pass through multiplexer 420 to program counter address 425. However, in the event that an initialization routine is to be executed, the output of flip flop 430 may be altered to cause multiplexer 420 to select initialized program counter 405 and drive it to program counter address 425. At the completion of the initialization routine, the program counter address 425 may be switched back to the running program counter 410 so that operations may be resumed from the last value prior to power loss. Switching the program counter may include the setting of a register bit or multiplexer. Here, flip flop 430 may be set using software or hardware. For example, software program counter switch 415 such as a register bit may be used to alter the output of flip flop 430. In another example, hardware reset switch 435 may be used to alter the output of flip flop 430. Some initialization routines may use the same type of switching circuit to switch a stack pointer, index register, and other working registers as needed.

In some embodiments, a program counter switch may also be used in context switching. Context switching may include the sharing of the processor between two programs. That is, a first program is executed, halted, and restarted after a second program is executed, and halted. In some embodiments, more than two programs may be included in context switching. Using a vertically configured non-volatile memory array for context switching may eliminate the need to swap register values into memory and may eliminate the risk of loss of data. That is, since vertically configured non-volatile memory arrays may have a small die size they may be configured densely, allowing each program to have a dedicated set of registers. Utilizing a dedicated set of registers may eliminate the moving of register values to memory and back again to switch programs. Since vertically configured non-volatile memory arrays may retain values through a power loss, there may be no risk of losing data. Thus, in using a vertically configured non-volatile memory array, a set of registers may be associated with a first program and a second set of registers may be associated with a second program, both of which are not at risk of being lost in a power loss creating an efficient context switch platform.

FIG. 4B illustrates an exemplary context switch 450. Register file 455 may include two programs and two sets of registers. A software program counter switch 465 and/or a hardware reset switch 470 may be used as inputs into a flip flop 460. Flip flop 460 may be used to select the program to be executed via determining which program counter is driven to program counter address 480. Register file address selects 475 may be used to select the registers that are associated with each of the programs. That is, when a program is selected to be executed, the associated registers are selected via the register file address selects. The register sets may be similar in some fashion. For example, a portion of the addresses of the register sets may be the same. In some embodiments, the lower address portion of the register sets are similar such that a most significant bit of a register file may be used as a register file address select. That is, upon a most significant bit being set to 1, one program would use the registers in the upper address portion of the register file. Upon the most significant bit being set to 0, a second program would use the registers in the lower address portion of the register file. In another embodiment, the upper address portion of the register sets are similar such that a least significant bit of a register file may be used as a register file address select. That is upon a least significant bit being set to 1, one program would use the odd addresses in the register file. Upon a least significant bit being set to 0, a second program would use the even addresses in the register file.

### Vertically Configured Non-Volatile Memory Arrays for Registers and Memory

FIG. 5 illustrates an exemplary processor 500 utilizing a vertically configured non-volatile memory array for both the register block and the memory block. Here, processor 500 illustrates vertically configured non-volatile memory array 505 replacing memory block 128. In addition to all the benefits of a processor with its registers configured in a vertically configured non-volatile array, the vertically configured non-volatile memory array 505 in processor 500, may allow the assembly instructions, a basic input output system (BIOS), and/or boot sector program may be stored in the processor as opposed to storing it on a separate ROM chip or on the hard disk. Storing the assembly instructions, a BIOS program, and a boot sector program within processor 500 in the vertically configured non-volatile memory array allows processor 500 to retain the programs through a power loss. Thus, the assembly instructions, boot up routine, boot sector program or other low level program stored on the processor memory are available upon the power being restored. That is, these programs would not have to be loaded from ROM, a hard drive, or boot up disk to return the processor to operational status when the power is restored. In other words, processor 500 is a processor without a ROM chip. In some embodiments, an operating system may be stored as well. In this case, the step of loading the operating system from hard disk may be eliminated. In some embodiments, enough memory may be included in vertically configured non-volatile memory array 505 to execute the programs as well as to store the programs. That is, vertically configured non-volatile memory array 505 may be used to replace ROM and RAM in a processor and have the boot up program and/or operating system execute within processor 500.

Program counter switching and context switching may be implementing using a processor that has both its registers and memory configured in a vertically configured non-volatile memory array. The implementation may be the same as shown with reference to a processor that has the registers only configured in a vertically configured non-volatile memory array, as discussed in reference to FIGS. 4A and 4B.

FIG. 6 illustrates an exemplary physical layout 600 of a processor including processor logic, registers, and memory configured in a vertically configured non-volatile memory array. In some embodiments, the physical layout of a processor configured in a vertically configured non-volatile memory array may include a plurality of layers. The logic for the processor may be implemented on the bottommost layer of the processor, base layer 605. The logic for the processor may include, for example, logic for control block 108, for register block 120, and for arithmetic block 130 of processor 500. The instructions stored in vertically configured non volatile memory array 505 may include BIOS, a boot sector program, assembly instructions, operating system, drivers, or any combination thereof. The stackable non-volatile registers or stackable non-volatile memory for processor 500 used with control block 108, register block 120, and control block 130 may be configured in register layer 610 stacked above base layer 605. The memory used with, or associated with, the BIOS, boot sector program, operating system or other programs may be located in program memory layers 615 and 620. Vias may be used to communicate between base layer 605 and layers 610, 615, and 620. In another embodiment, processor 500 may be configured in more or less layers than depicted here. The registers in this embodiment may be implemented in stackable non-volatile registers, stackable non-volatile memory or a combination of the two. In some embodiments, the registers, or some portion of them, may be located on base layer 605.

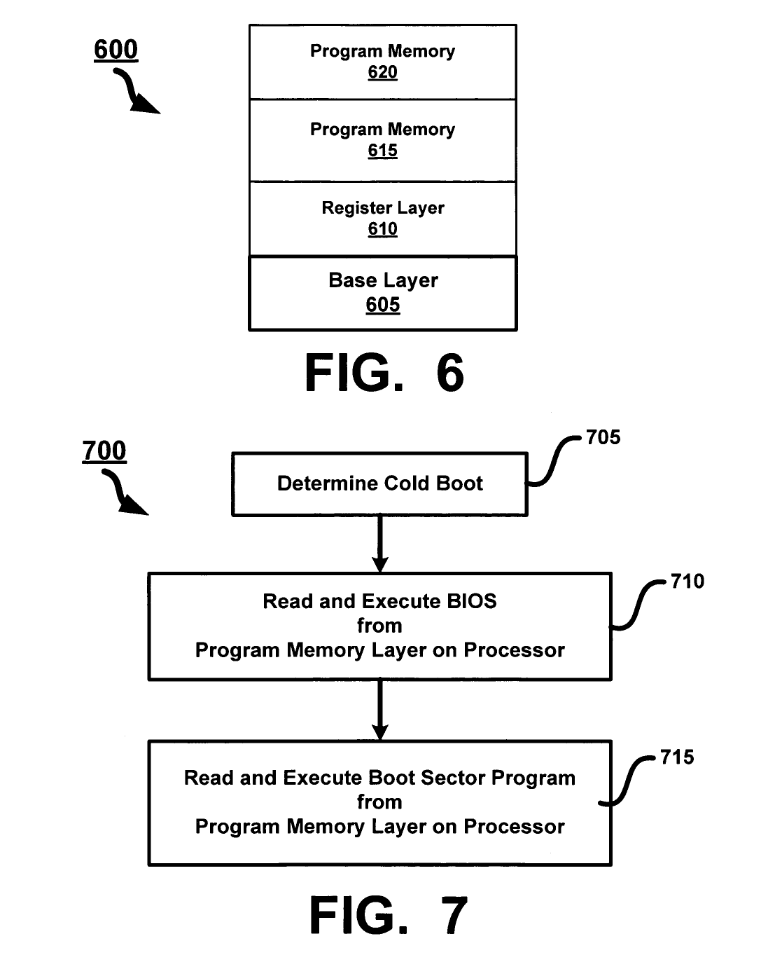

FIG. 7 illustrates an exemplary process 700 for a cold start. A cold start may be considered a powering up of a processor wherein the registers have not been set, or a start from zero. A cold start may be referred to as a cold boot, a power up, a cold start, a hard boot, hard power up, hard reset, or similar terms. In some embodiments, a cold start process may include determining the boot up is a cold boot at a stage 705, reading and executing the BIOS at a stage 710, and reading and executing the boot sector program at a stage 715. Determining that the boot up is a cold boot may include reading a particular register. In some embodiments register address 0000:0472 is loaded with value ox1234 to indicate a reboot. If this value is not in address 0000:0472, then the power up is a cold boot. The BIOS may be read and executed from a program memory layer in the processor at the stage 710. That is, a program memory layer may hold the BIOS program, while the execution of the BIOS may be carried out in the logic layer of the processor. Thus, the BIOS program need not be loaded from ROM into RAM to be executed. The BIOS is already in RAM and may be executed directly. The BIOS program may be programmed to perform a power-on self-test (POST) for the hardware in the system to ensure proper functionality. The BIOS may be programmed to activate the BIOS on other chips in the system, such as a small computer system interface (SCSI) card. The BIOS may provide a set of low-level routines that act as an interface between the hardware and the operating system. The BIOS may manage a collection of settings for the hardware in the system. The BIOS may send control signals for checking the BIOS settings, loading the interrupt handlers, testing the video card, verifying memory ports, displaying system information, and displaying error information. The boot sector program may be read and executed from a program memory layer in the processor at the stage 715. That is, a program memory layer may hold the boot sector program, while the execution of the boot sector program is carried out in the logic layer of the processor. Thus, the boot sector program need not be loaded from ROM or hard disk into RAM to be executed. The boot sector program is already in RAM and may be executed directly. The boot sector program may be configured to call portions of the operating system however, since the operating system also may be configured in the memory layers, it need not be loaded from the hard disk speeding up the operating system activation and overall processor readiness.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A processor comprising:
a register block configured to store and retrieve one or more values, the register block being a vertically configured non-volatile memory array;
an arithmetic block configured to perform an arithmetic operation on the one or more values; and
a control block configured to control the register block, the arithmetic block, and a memory block.

2. The processor of claim 1, wherein the register block retains the one or more values through a power loss.

3. The processor of claim 2, wherein one of the one or more values retained through the power loss determines IO pin direction.

4. The processor of claim 1, wherein two consecutive writes can be performed on the one or more values.

5. The processor of claim 1, wherein the one or more values retains a last state of the processor prior to a power loss.

6. The processor of claim 5, wherein the control block is further configured to restart from the last state.

7. The processor of claim 1, wherein the control block is further configured to resume operations from a last state of the processor stored in the register block after a power loss.

8. The processor of claim 1, wherein the vertically configured non-volatile memory array has no more than 2 terminals per cell.

9. The processor of claim 1, wherein the vertically configured non-volatile memory array comprises one or more stackable stand alone cells.

10. The processor of claim 1, wherein the vertically configured non-volatile memory array comprises an array of stackable cells.

11. The processor of claim 1, wherein the vertically configured non-volatile memory array comprises a combination of one or more stackable stand alone cells and an array of stackable cells.

12. A processor configured in a vertically configured non-volatile memory array, the processor comprising:
a register block configured to store and retrieve one or more register values;
a memory block configured to store one or more memory values; and
logic including
an arithmetic block configured to perform an arithmetic operation on the one or more register values, and
a controller block configured to control the register block, the memory block, and the arithmetic block.

13. The processor of claim 12, wherein the logic is configured in a first layer of the vertically configured non-volatile memory array.

14. The processor of claim 13, wherein the register block is configured in a second layer of the vertically configured non-volatile memory array.

15. The processor of claim 14, wherein the register block comprises one or more stackable stand alone cells.

16. The processor of claim 14, wherein the register block comprises an array of stackable cells.

17. The processor of claim 14, wherein the register block comprises a combination of one or more stackable stand alone cells and an array of stackable cells.

18. The processor of claim 14, wherein the memory block is configured in a second layer of the vertically configured non volatile memory array.

19. The processor of claim 18, wherein the memory block comprises an array of stackable cells.

20. The processor of claim 14, wherein the memory block is configured in a second layer and a third layer of the vertically configured non-volatile memory array.

21. The processor of claim 14 and further configured to retain the one or more register values and one or more memory values through a power loss.

22. The processor of claim 21, wherein one of the one or more register values retained through the power loss determines IO pin direction.

23. The processor of claim 14 and further configured to resume operations after a power loss based on the one or more register values.

24. The processor of claim 13, wherein the logic further comprises context switching.

25. The processor of claim 13, wherein the logic further comprises a basic input and output system.

26. The processor of claim 13, wherein the logic further comprises a boot sector program.

27. The processor of claim 12, wherein the logic further comprises a multiplexer, the multiplexer configured to select between a first program and a second program, the first program and the second program sharing the processor, and
the register block further comprises a select register, the select register configured to select an output of the multiplexer, a first register set associated with the first program, and a second register set associated with the second program, the first register set and second register sets being substantially identical and configured to retain values through a power loss.

28. The processor of claim 27, wherein the select register is a most significant bit of the register block, such that the first register set uses upper addresses of the register block and the second register set uses lower addresses of the register block.

29. The processor of claim 27, wherein the select register is a least significant bit of the register block, such that the first register set uses even addresses of the register block and the second register set uses odd addresses of the register block.

30. A method for resuming operations of a processor, comprising:
determining that a power up was preceded by a power loss;
reading one or more values from one or more processor registers, the one or more processor registers being vertically configured non-volatile memory operative to retain the one or more values through the power loss; and
resuming operations based on the one or more values.

31. The method of claim 30, wherein the resuming operations further comprises bypassing a portion of a basic input output system program.

32. The method of claim 30 and further comprising:
determining that an initialization routine is required, the determination based on the one or more values; and
executing the initialization routine prior to the resuming operations.

33. The method of claim 32, wherein the resuming operations further comprises transferring from a default program counter to a main program counter, the default program counter being a register used upon restart containing a pointer to a next memory location to be fetched in the initialization routine, the main program counter being a register containing a pointer to a next memory location to be fetched upon the resuming operations.

34. The method of claim 32, wherein the resuming operations further comprises transferring from a default stack pointer to a main stack pointer, the default stack pointer being a register used upon restart and identifying a location in the stack of a most recently referenced stack item in the initialization routine, the main stack pointer being a register identifying a location in the stack of a most recently referenced stack item prior to the power loss.

35. The method of claim 32, wherein the resuming operations further comprises transferring from a default index register to a main index register.

36. The method of claim 32, wherein the initialization routine includes instructions for clearing one or more I/O registers.

37. The method of claim 30, wherein the one or more process registers store values of a last state of the processor prior to the power loss.

38. The method of claim 30, wherein the reading one or more values from the one or more process registers further comprises reading the last state of the processor prior to the power loss.

39. The method of claim 38, wherein the resuming operations further comprises resuming operations from the last state of the processor.

40. A method for booting up a processor, comprising:
determining the boot up was not preceded by a power loss;
reading and executing a basic input and output system (BIOS) stored in a first memory layer of the processor in a vertically configured non-volatile memory array, the BIOS executed in a logic layer positioned substantially under the first memory layer in the vertically configured non-volatile memory array; and
reading and executing a boot sector program stored in a second memory layer positioned substantially above the first memory layer, the boot sector program executed in a logic layer positioned substantially under the first memory layer in the vertically configured non-volatile memory array.
